(19) United States
(12) Patent Application Publication
(10) Pub. No.: US 2003/0103156 A1
(43) Pub. Date: Jun. 5, 2003

(54) Camera user interface

(76) Inventors: Wilfred F. Brake, Fort Collins, CO (US); Amy E. Battles, Windsor, CO (US); Robert Cazier, Fort Collins, CO (US); Scott A. Woods, Bellvue, CO (US); David J. Staudacher, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/000,024

(22) Filed: Dec. 4, 2001

(51) Int. Cl. H04N 5/222

(52) U.S. Cl. 348/333.01

(57) ABSTRACT

A camera user interface assembly including at least one object viewer, a resizeable, image-capture-area designator superimposed on said at least one object viewer and a size selector operatively associated with said designator.

### BACKGROUND

Digital cameras are devices that produce digital image data representative of an image of an object. As used herein “digital camera” refers to any camera, still or motion picture, which generates such image data. The image data generated by a digital camera may be transmitted to a memory device for storage or to an output device such as a video monitor or a printer that produces a replicated image of the object. A digital camera may have on-board data storage media such as film, video cassettes, video disks, memory cards or other image data storage media.

A digital camera typically has optical elements, at least one two-dimensional photodetector array, a data storage device, a controller and a display, all of which are generally mounted to a camera housing. Digital cameras are described in the following patents which are hereby incorporated by reference for all that is disclosed therein. U.S. Pat. No. 4,131,919 of Lloyd et al. issued on Dec. 26, 1978 under the title ELECTRONIC STILL CAMERA, U.S. Pat. No. 4,420,773 of Toyoda et al. issued on Dec. 13, 1983 under the title ELECTRONIC PHOTOGRAPHIC CAMERA and U.S. Pat. No. 4,541,010 of Alston issued on Sep. 10, 1985 under the title ELECTRONIC IMAGING CAMERA.

The digital camera's optical elements serve to focus an image of an object onto the camera's two-dimensional photodetector array. The optical elements typically comprise one or more lenses and/or reflectors. The two-dimensional photodetector array generates image data representative of the image of an object imaged onto it. The controller serves to process the image data and to transfer the image data to and from the data storage device. The controller also serves to transfer image data to the display and the output device.

The two-dimensional photodetector array has a plurality of photodetectors typically arranged in closely positioned rows and columns. Each photodetector generates image data representative of a small portion of the optical image of the object that is focuses on the photosensor array. The accumulation of image data generated by the plurality of photodetectors is representative of the entire image of the object, similar to a mosaic representation of the image of the object. Each photodetector outputs a data value which corresponds to the intensity of light it receives. The controller processes and arranges the image data generated by the plurality of photodetectors into a complete set of image data.

Digital cameras are often provided with a ‘zoom’ function whereby the user may increase or decrease magnification of the image data. The outcome of ‘zooming-in’ on an object is that the subsequent replication of the image data on an output device, e.g. a printer, is magnified. The outcome of ‘zooming-out’ is that the replication is demagnified. The zoom function may be accomplished through use of an ‘optical zoom’ or a ‘digital zoom’. Optical zoom is accomplished through the displacement of lenses, while digital zoom utilizes cropping of the image data. When image data is cropped, data from only that portion of the photodetector array which correspond to the ‘zoomed-in’ portion of the object is used. With digital zoom, the cropped image data may be interpolated to increase resolution somewhat, or alternatively, may remain as cropped image data. In most conventional digital cameras, the user selects the proper digital or optical zoom magnification by viewing the effects of zooming on the camera's video display screen. The display usually shows only the zoomed-in portion of the object being imaged.

When digitally zooming an object to be imaged, the real-time display of the image data on the display is often compromised. For example, the interpolation of cropped data to improve resolution requires processing time which slows the refresh rate of the display. A slowing of the refresh-rate results in a ‘choppy’ display of the successive images produced on the display. Additionally, by zooming, either digitally or optically, the user looses the field-of-view of the digital camera as seen through the display. Sometimes it can become difficult to determine whether the desired portion of the object has been zoomed. As a result, the user must scan the camera back and forth over an object while monitoring the display; then, once the desired area to be captured is seen on the display, the user may then invoke the controller to capture the image data.

A digital camera sold by Panasonic under the name IPALM, model PV-DC3000 includes a mode button which may be pressed repeatedly to sequentially select a recording mode of: tagged image format, super fine, fine, normal, 2× zoom, 3× zoom, motion image, or burst. In the 2× zoom mode a box appears within a digital display showing an area that will be captured. In the 3× zoom mode, a still smaller box appears in the digital display showing an area that will be captured.

### SUMMARY

In one embodiment, the invention may comprise a camera user interface assembly comprising: at least one object viewer; a resizeable, image-capture-area designator superimposed on the at least one object viewer; a size selector operatively associated with the designator having at least one operating mode wherein the size selector is operable exclusively to resize the superimposed designator.

In another embodiment, the invention may comprise a method of operating a camera comprising: displaying indicia representative of a portion of a displayed image which is to be selected for capture; and continuously resizing the indicia from a smaller size to a larger size and from the larger size the smaller size.

In another embodiment, the invention may comprise a camera user interface comprising: means for displaying an image of an object; means for designating a portion of the displayed image; and means for continuously adjusting the size of the means for designating from a smallest size to a largest size and from the largest size to the smallest size.

### BRIEF DESCRIPTION OF THE DRAWINGS

FIG. 1 is a rear view of a camera.

FIG. 2 is a schematic cross-section view of the camera taken across plane 2-2 of FIG. 1.

FIG. 3 is a block diagram showing certain features of a camera.

FIG. 4 is a rear view of a second camera.

### DETAILED DESCRIPTION

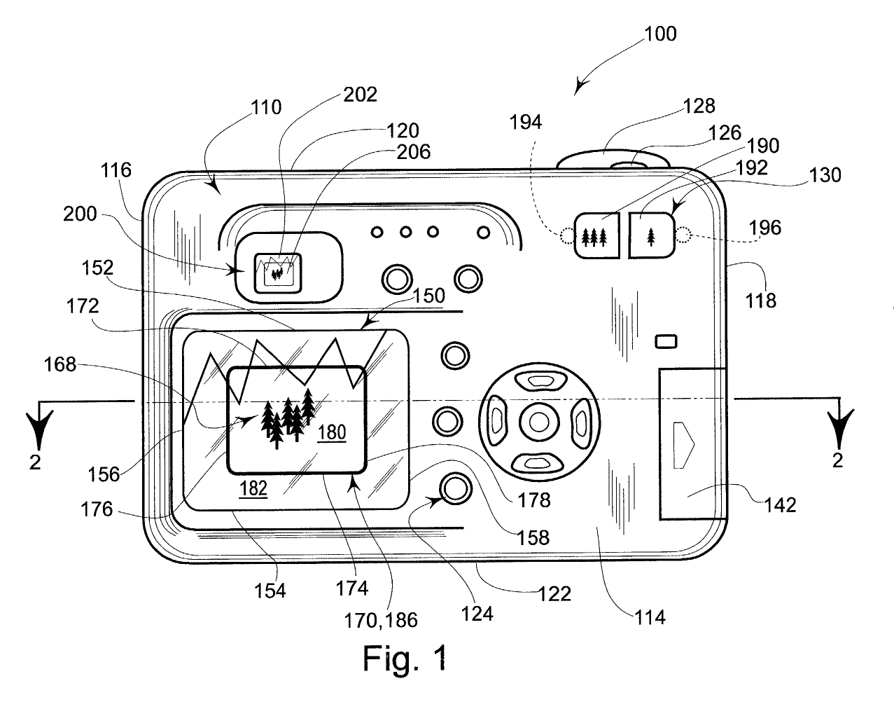

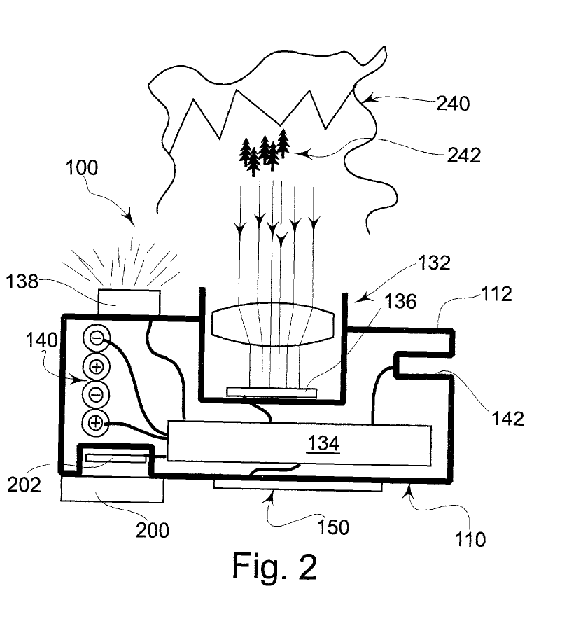

FIG. 1 shows a digital camera 100 having a housing 110. The housing 110 may have a front 112 (FIG. 2), a back 114, a left side 116, a right side 118, a top 120 and a bottom 122. The camera 100 may be provided with a plurality of user interfaces such as a mode button 124, a power button 126, a capture button 128 and a zoom toggle device 130 for operating the camera 100.

With reference to FIG. 2, the camera 100 may include a lens assembly 132, a controller 134 and a photosensor array 136. The photosensor array is typically one or more two-dimensional arrays. When used for color photography the photosensor array may be a matrix of color sensors or the imaging light beam may be split into multiple beams focused onto multiple photosensor arrays for generating multiple color component data sets. As used herein ‘photosensor array’ refers to both single array and multiple array type photosensor assemblies. The camera could include other components such as a flash 138, a power supply 140 and a storage media interface 142. The lens assembly 132 may be mounted to the camera housing front 112 in optical communication with the photosensor array 136. Light passing through the lens assembly 132 forms an image of an object 240 on the photosensor array 136. The photosensor array 136 generates image data representative of the image of the object formed thereon in a manner previously described and well known in the art. The photosensor array 136 and other components such as the flash 138, the power supply 140 and the storage media interface 142 may be placed in electronic communication with the controller 134 by conventional electronic interfaces such as conductor wires, circuit boards, etc.

With reference to FIG. 1, the camera 100 may be further provided with a display 150. In one embodiment the digital camera 100 may have a display 150 mounted on the camera back 114. However, it is to be understood that in other digital camera embodiments the display may be mounted on any of the other portions (e.g., 112, 116, 118, 120, 122) of the camera housing 110 or may even be detachable from and independently positionable relative to the housing 110 while remaining functionally connected to other components in the housing 110 as by wires, electromagnetic transmission, etc. The display 150 may be any of a variety of shapes, however commonly the shape is generally rectangular. The display 150 may have a top edge 152, a bottom edge 154, a left edge 156 and a right edge 158. The display 150 may be of any type including but not limited to display types now known in the art, such as a liquid crystal display (LCD), cathode ray tube display (CRT), light emitting diode display (LED), ferroelectric display, plasma display, etc. Image data of an object is displayed on the display 150 as a display image 168 which fills the display 150.

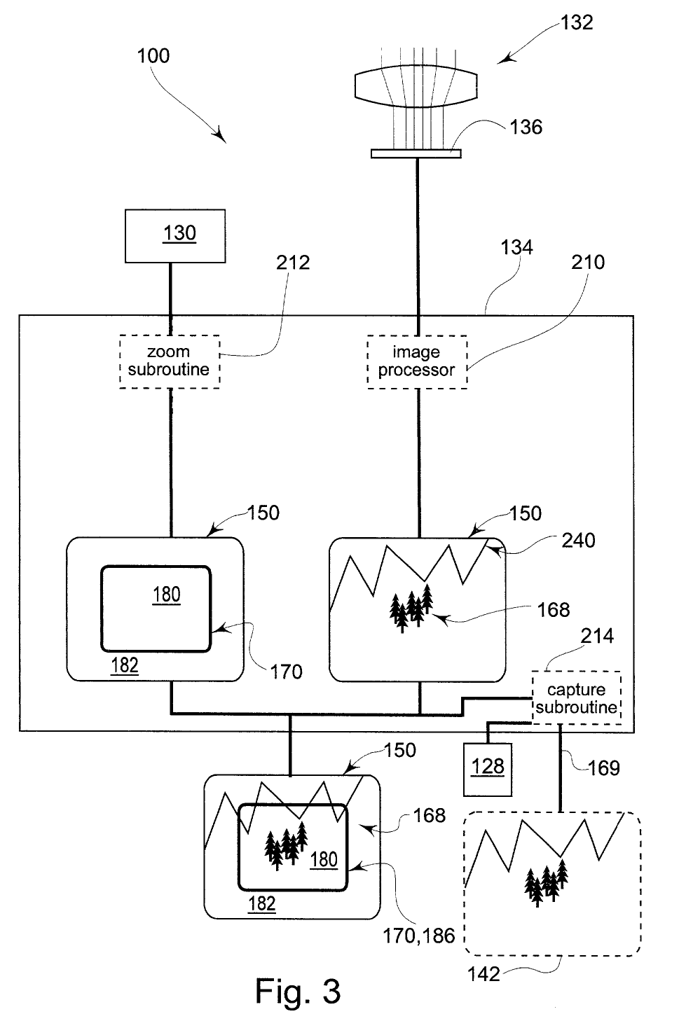

With further reference to FIG. 1, the camera 100 may be provided with a zoom area indicator 170 superimposed on the display image 168 delineating a zoomed area 180 of the image from a periphery area 182 thereof. The superposition of the zoom area indicator 170 over the image 168 may be provided by a zoom-subroutine 212 of the controller 134 (FIGS. 2 and 3). The controller 134 may have an arithmetic processing unit containing an algorithm for superimposing the zoom area indicator 170 over the display image 168 of the object. Such superposition of the zoom area indicator 170 on the display 150 indicates to the user that the zoomed area 180 of the display image 168 may be captured as image data. The zoomed area indicator 170 is also referred to herein as the ‘image-capture-area designator’. The area indicator 170 may be of any shape but typically includes a top edge 172, a bottom edge 174, a left edge 176 and a right edge 178. The area indicator 170 may delineate the zoomed area 180 from the periphery area 182 in any of a variety of ways. As best shown in FIG. 1, one non-limiting example of a zoom area indicator 170 is a line box 186. The line box 186 may include line sections that reside on the top, bottom, left and right edges 172, 174, 176 and 178 of the zoom area indicator 170. The line box 186 may be any color, such as white, red or black, by way of a non-limiting example. Additionally, the line width of the box 186 may be any width visible to most users, such as, by way of non-limiting example, 0.1 mm, 0.5 mm, 1 mm or other widths.

The term ‘toggle’ as used herein means any selector device that may be used for adjusting an operating parameter. With reference to FIG. 1, the zoom toggle device 130 sometimes referred to as a ‘size selector’ herein may employ various types of toggles including, but not limited to, two or three way discrete position toggles, pressure sensitive toggles, dials and other rotary devices, slide toggles, or any other devices now known or later developed that allows a user to progressively scroll through or display a subject parameter. The size selector or toggle device may produce size changes in discrete steps for example one step with each push of a button or may operate without stopping, e.g. the size of the box 170 increases up to the maximum size as long as the button is held down. The toggle may operate in a one way closed loop or may be a two way toggle allowing for one type operation to increase size and an opposite operation to decrease size. The toggle may be of a ‘continuous’ sizing type which means that it is operable to move the indicator 170 back and forth progressively through its full range of sizes large to small and small to large without encountering any other operating modes not associated with the indicator 170. For example if it were necessary to enter a tagged image format operating mode, in order to go from a 3× zoom to a 2× zoom this would not be a ‘continuous sizing’ operation. In one embodiment the selector has at least one operating mode where it is operable only to resize the indicator 170. Such operation, in one embodiment, is its only operating mode. In other embodiments the toggle may be used in different selected operating modes to adjust different parameters. One such toggle device 130 is a pair of buttons, hereinafter referred to as a zoom-out button 190 and a zoom-in button 192 having a first switch 194 and a second switch 196 operatively associated therewith, respectively. Actuation of the buttons 190, 192 results in closing or opening of either the first or second switch 194, 196, thereby invoking ‘zooming’ of the display image 168 (i.e., increasing or decreasing the zoomed area 180).

Use of digital camera 100 to capture a 1× image will now be described. The zoom ratio scale indicates the magnification of an image and/or image data with-respect-to the camera's 1× zoom ratio. The 1× zoom ratio is the camera's standard operating condition wherein no zoom is provided, either optically or digitally. The 1× zoom of the camera 100 is determined by the layout of the lens assembly 132 and any image data manipulation performed by the controller 134. In a non-limiting example, provided for descriptive purposes only, the zoom of an exemplary camera 100 may be, say, between 1.2× and 7× (i.e. providing a 20 percent to 700 percent increase of size over the 1× zoom of the camera 100). With further reference to FIG. 2, the user may desire to capture an image of an object, such as a picturesque mountain scene 240. With reference now to FIG. 1, at the outset, the user turns-on the camera 100 by depressing the power button 126. Depressing the power button 126 may cause any of a number of functions to begin, such as, for example, opening of an iris-type lens cover (not shown), charging of a flash capacitor (not shown) and display of image data as the display image 168 on the display 150. Image data may be obtained by passing light reflected from object 240 through the lens assembly 132 (FIG. 2) to produce an optical image of the object on the photosensor array 136. The photosensor array 136 generates digital image data representative of this image of the object being imaged. The image data is transferred electronically to the controller 134 to which the photosensor array 136 is connected.

The controller 134, certain operations of which are shown schematically in FIG. 3, may perform a variety of mathematically derived functions implemented by an image processor 210 to interpolate the data and generate interpolated image data (in another embodiment no interpolation takes place and the raw image data is used). The interpolated image data 211 is then sent from the controller 134 to the display 150, the storage media interface 142 and/or another connected device such as a computer or printer (not shown). With the present exemplary application directed toward capturing a mountain scene 240, the interpolated image data of the mountain scene 240 is then displayed on the display 150 as display image 168. The display image 168 of the mountain scene 240 is shown on the display 150 at the 1× zoom. The display image 168 of the mountain scene 240 that is shown on the display 150 extends from the top edge 152 to the oppositely disposed bottom edge 154 and from the left edge 156 to the oppositely disposed right edge 158. The user may ‘preview’ the image data that will ultimately be stored by the camera 100. During previewing, the user may move the camera 100 from left to right and/or up and down until the image of a desired scene, e.g. mountain scene 240 is displayed on the display 150. Once the desired image, e.g. image 168 of the mountain scene 240, is displayed on the display 150, the user may capture the image data.

The image data may be captured by depressing the capture button 128, which notifies the controller 134 to capture the image data of the mountain scene 240 used to produce the currently displayed image 168. The controller 134 may perform any of a number of actions required to capture the image data through use of a capture subroutine 214. One such action to capture image data may be to store it on a memory device 142, such as a memory card. The image data may be stored on the memory card for later use in any of a variety of applications such as display on a computer monitor, printing of images, copying to other storage devices, etc.

The previous description was directed to a 1× capture of imaged data representative of an object. The following description, with reference to FIGS. 1 and 3, will be directed towards a capture of ‘magnified image data’, for example without limitation, image data magnified on a display 150 between, say, 1.2× and 7×. The reason for selecting such magnification ratio, e.g. 1.5×, may be that the user desires to capture a particular feature in an object, but no the entire object itself. One such exemplary scenario would be if a particular group of trees 242 (FIG. 2) in the aforementioned picturesque mountain scene 240 were desired to be captured. The user may depress the zoom buttons 190, 192 of the toggle device 130 to direct the controller 134 to indicate a proper digital zoom ratio. Depending on which portion of the digital zoom buttons 190, 192 is depressed, the size of line box 170, which appears when either button is depressed, will increase or decrease. By depressing the zoom-in button 192, the second switch 196 located under the zoom button 192 notifies the controller 134 of the user's intent to capture a smaller portion of the image of the object. By depressing the zoom-out button 190, the first switch 194 located under the zoom button 190 notifies the controller 134 of the user's intent to capture a larger portion of the object. Upon depression of either button 190 or 192, the controller 134 initially superimposes the line box 170 over the display image 168 appearing on the display 150. Depending upon which button 190, 192 is depressed and how long it is held (or alternatively the number of times it is pushed), the line box edges 172, 174, 176, 178 are caused to appear on the display 150 nearer the display edges 152, 154, 156, 158, or nearer the center region of the display 150. Such alternative location for the line box 170 depends upon the percentage of zoom selected. ‘Percentage of zoom’ is herein defied as the percentage of difference between the imaged area 180 to be imaged and the size of the entire display 150. For example, if the particular group of trees 242 to be captured in the mountain scene 240 accounts for one-fifth of the mountain scene as displayed on the display, then the user would increase the zoom until the line box 170 is properly sized at 5×. By properly sizing the line box 170, a desired zoomed image area 180 may be positioned inside the lined box 170 while the remainder of the display image 168 appears in the periphery area 182. In the event that the desired group of trees is not located in the center of the display 150, the user may pan or tilt the camera 100 to a position wherein the desired group of trees 242 is located inside the line box 170. Such alignment of the particular group of trees 242 in the box 170 is assisted by the presence of the entire display image 168 in the display 150, including the portion in the periphery area 182. The display periphery area 182 allows the user to see areas of display image 168 surrounding the desired image of the group of trees 242, which assists with positioning. Upon successful positioning of the desired group of trees 242 inside the line box 170, the user may invoke capturing of the image data. As previously described, the capture of image data may be invoked by depressing the capture button 128. By depressing the capture button 128, the controller 134 is notified to capture only the image data associated with the portion of the image 168 that is located in the box 170. This image data 169 is then captured and sent to memory media 142, FIG. 3 or other output devices, either directly or after interpolation, as shown schematically in FIG. 3.

With reference to FIG. 1, the camera 100 may be provided with a digital viewfinder 200 either in addition to or instead of display 150. The digital viewfinder 200 may include any one of a number of reduced size displays 202 such as a liquid crystal display (LCD), cathode ray tube display (CRT), light emitting diode display (LED), ferro-electric display, plasma display, etc. The digital view finder 200 may have features substantially similar to the display 150, but in a reduced format. To use the digital viewfinder 200, the user places an eye near and looks into the digital viewfinder 200. While looking into the digital viewfinder 200, the user sees a display image 206 on the reduced display 202 like the one produced on the display 150 as described above. The use of the digital viewfinder 200 may eliminate problems associated with sunlight on the display 150. Sunlight tends to diminish the viewability of display images data, such as display image 168, on the display 150. Thus the same type of zoom area indicator 170 and zoom functions as described above for display 150 may be provided with a digital viewfinder to obviate glare and other problems associated with using a larger unshielded display 150.

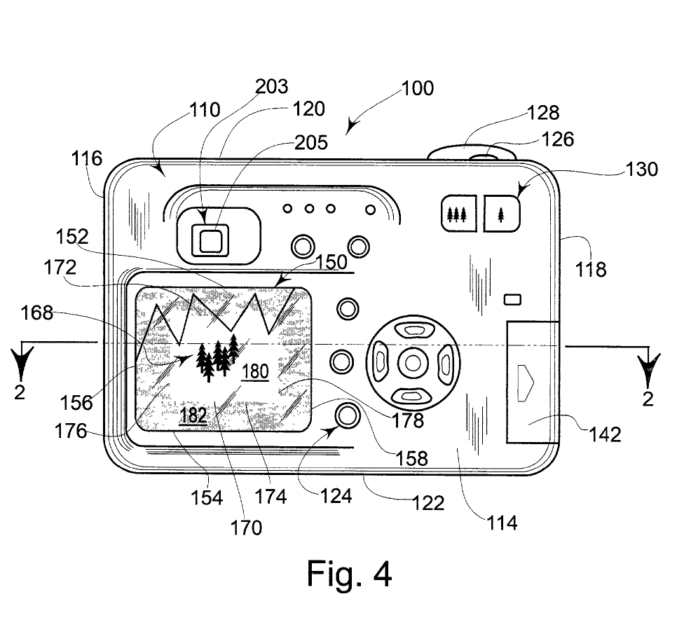

In an alternative embodiment, the camera 100 may be provided with a fixed optical viewfinder 203, FIG. 4. Fixed optical viewfinders 203 may be mounted on the camera 100 in a manner similar to a digital viewfinder 200 from an exterior perspective, however internally the optical viewfinder 203 is substantially different from the digital viewfinder 200. Although optical viewfinders are well known in the art, the basic operating principles will be briefly described. Light entering an optical viewfinder may be light entering the camera 100 through the lens assembly 132. A variety of devices may allow for the sharing of light coming into the camera 100, such as partially mirrored prisms, whereby the light beam passing through the lens is split and most light travels to the photosensor array 136 and some light travels to the optical viewfinder. In other viewfinders, although the viewfinder and lens are both pointed toward the same object, the light from the object which enters the viewfinder is not the same light from the object that enters the lens assembly. The fixed optical viewfinder has fixed optical elements that may be set at or near the camera base 1× zoom ratio. Thus what a viewer sees looking through the fixed optical zoom is about the same as the 1× zoom view shown on digital display 150. The fixed optical viewfinder 203 may be provided with a mechanism for superimposing the zoom area indicator 170 on the optical viewfinder viewing window 205. Such mechanism for superimposing zoom area indicator 170 may, for example, be a somewhat transparent liquid crystal display (LCD), an image projected onto an optical prism or mirror, or an image otherwise generated on an opaque LCD, LED, etc. and superimposed on the optical viewfinder. The indicator 170 could even be a mechanical assembly such as mechanically displaceable wires moved by a suitable actuator in response to commands provided by the controller 134. The superimposed area indicator 170 is shrunk or increased in size in response to touching the zoom toggle device 130 just like the zoom area indicator 170 on display 150. A fixed optical viewfinder may be used on a camera with or without a digital display 150. The term ‘object viewer’ as used herein refers to any feature on a camera which allows the user to view the object which is to be imaged and includes display devices and viewfinders.

In another embodiment as shown in FIG. 4, the camera 100 may be provided with a variation of the zoom area indicator 170. In-place-of the line box 170, a variation in quality of the display image 168 shown on the display 150 may be employed. The variation in image quality may be any of a number of schemes that serve to differentiate the zoomed area 180 from the periphery area 182. One such variation in the image quality is a change in contrast, whereby the periphery area 182 is either lightened or darkened with-respect-to the imaged area 180. Another variation in image quality may be a change in color; for example, the imaged area 180 may be shown in color, while the periphery area 182 is shown in black-and-white. Another variation would be differences in color hue between zoomed area 180 and periphery area 182. Yet another variation would be to display area 180 and 182 at different resolutions. Another variation would be to overlay line patterns on the periphery area 182. Other methods for differentiating the area 180 from the periphery area 182 may also be used as will be appreciated by those having skill in the art upon reading this disclosure.

In an alternative embodiment, information may be displayed in the periphery area 182 of the display 150. Such information which may be displayed includes, the file size of the image data and the scale of magnification of the image data.

While illustrative and presently preferred embodiments of the invention have been described in detail herein, it is to be understood that the inventive concepts may be otherwise variously embodied and employed and that the appended claims are intended to be construed to include such variations except insofar as limited by the prior art.

What is claimed is:

1. A camera user interface assembly comprising:
at least one object viewer;
a resizeable, image-capture-area designator superimposed on said at least one object viewer; and
a size selector operatively associated with said designator having at least one operating mode wherein said size selector is operable exclusively to resize said superimposed designator.

2. The assembly of claim 1 wherein said at least one object viewer comprises a display screen.

3. The assembly of claim 1 wherein said at least one object viewer comprises an optical viewfinder.

4. The assembly of claim 1 wherein said resizeable image-capture-area designator is a progressively increasingly and progressively decreasingly resizeable image-capture-area designator.

5. The assembly of claim 1 wherein said resizeable image-capture-area designator comprises a one-way, closed-loop resizeable image-capture-area designator.

6. The assembly of claim 1 wherein said resizeable image-capture-area designator comprises a discrete-step size, resizeable image-capture-area designator, each discrete-step resizing being associated with a discrete operation of said selector.

7. The assembly of claim 1 wherein said size selector comprises at least one of a: rocker toggle, single push button toggle, double push button toggle, slide toggle, continuous pressure toggle, joystick toggle, dial toggle and roller toggle.

8. The assembly of claim 1 wherein said resizeable, image-capture-area designator comprises at least one of: line border, contrast differential, color/black-and-white differential, gray scale differential, color hue differential, resolution differential, pattern overlay differential.

9. A camera comprising:
at least one object viewer;
a resizeable, image-capture-area designator superimposed on said at least one object viewer;
a size selector operatively associated with said designator having at least one operating mode wherein said size selector is operable exclusively to resize said superimposed designator.

10. A camera user interface assembly comprising:
at least one object viewer;
a resizeable, image-capture-area designator superimposed on said at least one object viewer;
a size selector operatively associated with said designator having at least one operating mode wherein said size selector is operable to continuously increase and continuously decrease the size of said designator.

11. A camera comprising:
at least one object viewer;
a resizeable, image-capture-area designator superimposed on said at least one object viewer;
a size selector operatively associated with said designator having at least one operating mode wherein said size selector is operable to continuously increase and continuously decrease the size of said designator.

12. A method of operating a camera comprising:
displaying indicia representative of a portion of a displayed image which is to be selected for capture;
continuously resizing the indicia from a smaller size to a larger size and from the larger size the smaller size.

13. A method of operating a camera comprising:
operating a selector switch through its entire range of operation to resize displayed indicia representative of a portion of a displayed image which may be selected for capture without invoking other operating modes of the camera;
operating an image capture selector to capture only image data representative of the portion of the displayed image designated by the indicia.

14. A method of taking a picture of an object comprising:
imaging a remote scene that contains the object on a two dimensional photodetector array;
generating a first set of image data representative of the remote scene;
viewing the image representative of the remote scene on a display screen;
superimposing an area designator on the display screen;
continuously shrinking and enlarging the area designator until a desired reduced portion of the display screen which contains only the object is within the area designator;
based upon the size of the area designator selecting a portion the first set of image data which corresponds to the object to generate a second set of image data;
storing the second set of image data.

15. A method of making a camera comprising:
mounting a display having a resizeable image-capture-area designator superimposing function on a camera housing;
mounting a toggle on the camera housing which is operable, in at least one operating mode, only for initiating display of the designator and resizing the designator.

16. A method of making a camera comprising:
mounting a display having a resizeable image-capture-area designator superimposing function on a camera housing;
mounting a toggle on the camera housing which is operable to continuously resize the image-capture-area designator over its full range of sizes.

17. A camera user interface comprising:
means for displaying an image of an object;
means for designating a portion of said displayed image; and
means for continuously adjusting the size of said means for designating from a smallest size to a largest size and from said largest size to said smallest size.

18. A camera user interface comprising:
means for displaying an image of an object;
means for designating a portion of said displayed image; and
means for manipulating said means for designating, exclusive of selection or adjustment of other features of said camera.

19. A camera comprising:
means for displaying an image of an object;
means for designating a portion of said displayed image; and
means for continuously adjusting the size of said means for designating from a smallest size to a largest size and from said largest size to said smallest size.

20. A camera comprising:
means for displaying an image of an object;
means for designating a portion of said displayed image; and
means for manipulating said means for designating, exclusive of selection or adjustment of other features of said camera.
